(19) United States
(12) Patent Application Publication
(10) Pub. No.: US 2025/0007107 A1
(43) Pub. Date: Jan. 2, 2025

(54) HARNESS ASSEMBLY

(71) Applicant: JAGUAR LAND ROVER LIMITED, Whitley, Coventry, Warwickshire (GB)

(72) Inventors: Lars GEHRKE, Whitley, Coventry, Warwickshire (GB); Bogdan BRINDUSA, Whitley, Coventry, Warwickshire (GB); Felipe RODRIGUES, Whitley, Coventry, Warwickshire (GB)

(21) Appl. No.: 18/701,145

(22) PCT Filed: Oct. 6, 2022
(86) PCT No.: PCT/EP2022/077831

§ 371 Date: Apr. 12, 2024

(30) Foreign Application Priority Data
Oct. 14, 2021 (GB) 2114679.0

(51) Int. Cl. H01M 50/519; B60L 50/64; B60R 16/02; H01B 5/14; H01M 10/42; H01M 10/48; H01M 10/653; H01M 50/213; H01M 50/249

(52) U.S. Cl. CPC H01M 50/519; B60L 50/64; B60R 16/0215; H01M 10/425; H01M 10/482; H01M 10/486; H01M 10/653; H01M 50/213; H01M 50/249; H01B 5/14; H01M 2220/20

(57) ABSTRACT

Disclosed is a harness assembly for a battery module of an electric vehicle, the battery module comprising first and second opposite end faces with a side located therebetween. The harness assembly comprises an electrically conductive track configured to be located along the side of the battery module; a temperature sensor electrically connected to the track; and a harness clip configured to fasten the track to the battery module and hold the temperature sensor in contact with an electrical cell of the battery module. Also disclosed is a harness comprising a primary track comprising a printed electrical conductor and configured to be located along the side of the battery module; and a branch track comprising a printed electrical conductor, electrically connected to the electrical conductor of the primary track and configured to be folded to locate it at least partially at a second side, different to the first side, of the battery module.

### TECHNICAL FIELD

The present invention relates generally to battery assemblies. In particular, but not exclusively, the invention relates to a harness assembly for use with a battery module used as a vehicle traction battery, for example for a Battery Electric Vehicle (BEV). Aspects of the invention relate to a harness, harness assemblies, battery module assemblies, battery packs, vehicles, and methods of forming a harness assembly for a battery module.

### BACKGROUND

There has recently been increased interest in providing battery-powered vehicles, which has led to developments in vehicle batteries, in particular vehicle traction battery technology.

Vehicle traction batteries often comprise one or more modules each containing a plurality of cells. It is desirable to be able to monitor the properties and behaviour of the cells in the module. For example, temperature monitoring of the cells in the module can provide a valuable measure of cell health and battery module operation. Due to the nature of battery packs used in vehicles, the battery modules need to be sturdy and robust in order to withstand repeated movements due to the vehicle being driven (e.g. vibrations, shocks and bumps).

In relation to temperature monitoring, there is a need for accurate temperature monitoring during use of the battery modules in a way which remains reliable and robust through the battery lifetime. Therefore, accurate and secure placement of temperature sensors in the battery module is desirable, as well as a robust way of providing sensed data from a temperature sensor to an output of the battery module. For example, it is desirable for any electrical pathways or connections between a temperature sensor and an output of the battery module to be reliable and securely formed in a compact and easily-manufactured way.

### SUMMARY OF THE INVENTION

According to an aspect of this disclosure, there is provided a harness assembly for a battery module of an electric vehicle, the battery module comprising first and second opposite end faces with a side located therebetween, the harness assembly comprising: an electrically conductive track configured to be located along the side of the battery module; a temperature sensor electrically connected to the track; and a harness clip configured to fasten the track to the battery module and hold the temperature sensor in contact with an electrical cell of the battery module.

The track and clips in combination both hold the harness assembly securely in place and help ensure good contact of the temperature sensor(s) with the electrical cell(s) they are adjacent to and retain the electrical connecting track in position along the side of the battery module. A compact battery module with securely retained sensor(s) and electrical connection(s) may be obtained using readily manufactured clips which are straightforward to install in the module.

The electrically conductive track may be configured to be located along the side of the battery module from the first to the second end faces.

The temperature sensor may comprise a thermistor. The thermistor may be potted in thermally conductive material. Potting the thermistor may help ensure good thermal contact with the electrical cell being monitored, in combination with the harness clip holding the potted thermistor against the electrical cell.

The battery module may comprise a plurality of electrical cells each having parallel longitudinal axes aligned in a first direction parallel to the plane of the side of the battery module.

The temperature sensor may be located at a first end of the track, and the harness clip may be configured to fasten the first end of the track to an end face of the battery module and hold the temperature sensor in contact with an electrical cell at the end of the battery module. It may be advantageous to monitor the electrical cell temperature at the end of the battery module as this position may provide the highest temperature of the module (that is, the cells at the end of the module may tend to get the hottest and are thus the first cells to reach a high enough temperature to require intervention to cool them down to guard against diminished performance). Thus a critical location, at the end portion of the battery module, may be temperature monitored with a securely attached sensor.

The harness clip may have a profile shaped to follow a curved surface of the end of the battery module and fasten the first end of the track to an end face of the battery module causing the first end of the track to conform to the curved surface. Conforming the track to the curved surface in this way holds the track securely to the harness, mitigates against damage to the track if it was not held against a surface and present as “loose” wiring, and requires little additional space to accommodate the track as part of the battery module.

The harness assembly may comprise a plurality of temperature sensors located at the first end of the track. The harness clip may be configured to hold the plurality of temperature sensors in contact with the electrical cell at the end of the battery module. Thus the temperature at different regions along the battery module may be monitored.

The harness clip may be configured to fasten the track to the side of the battery module and hold the temperature sensor in contact with an electrical cell at the side of the battery module. An electrical cell may have first and second opposite ends and a side therebetween, having a longitudinal axes through the first and second ends. The temperature sensor may be held at the side of a cell, midway between the first and second ends. The side of the electrical cell may be the most sensitive region to temperature fluctuations and thus the most accurate region to monitor for temperature and changes in temperature. Some electrical cells such as rechargeable chemical cells may have air gaps between the active battery components within a cell casing/cannister, and the cell casing/cannister at the ends of the cell. Less reliable temperature monitoring may be performed in the regions where there are air gaps present because the air gap reduces the thermal conductivity from the battery cell to the temperature sensor.

The harness assembly may comprise a connector at a second end of the track. The connector may be configured to connect to a battery module controller and provide electrical signals from the track to the battery module controller. The temperature sensor may be located towards the second end of the track and the connector. The connector allows for electrical signals from the temperature (and any other) sensors in the battery module to be provided to an externally accessible output of the battery module for readout (e.g. to a battery module controller).

The harness assembly may comprise: a first temperature sensor located at a first end of the track, wherein a first harness clip is configured to fasten the first end of the track to an end face of the battery module and hold the first temperature sensor in contact with a first electrical cell at the end of the battery module; and a second temperature sensor, wherein a second harness clip is configured to fasten the track to the battery module and hold the second temperature sensor in contact with a second electrical cell at the side of the battery module. Thus temperature sensors may be included at different locations in the battery module to measure the temperature of different battery module cells and provide a complete battery module temperature profile.

The temperature sensor may be in contact with, and bonded to, the electrical cell of the battery module. For example, the temperature sensor may be potted in thermally conductive material and the potting material may be cured once the potted temperature sensor is in position on the battery cell. Completing the curing once the potted sensor is in position may help to retain the sensor in the same position on the cell by bonding the sensor to the cell.

The harness clip may be configured to clip onto a cell carrier of the battery module. The cell carrier may support the plurality of electrical cells of the battery module in an array. The harness clip may be configured to clip onto a structural rib portion of the cell carrier of the battery module. Thus the clips may have clip retaining elements which cooperate with clip retaining elements in the cell carrier to allow the clips to easily fasten onto the cell carrier.

The harness clip may comprise a central portion and a pair of clip tabs at opposite sides of the central portion. The harness clip may be configured to hold the track between the pair of clip tabs and sandwich the track between the central portion and the battery module. The harness clip may be configured to hold the temperature sensor in contact with an electrical cell of the battery module by sandwiching the temperature sensor between the central portion and the battery module with the pair of clip tabs located at respective opposite edges of the track. In this way the track is easily positioned in the correct place as the clip houses the track and the clip attaches to the battery module (e.g. cell carrier) in a predetermined clipping location. by sandwiching the temperature sensor between the module and the clip, good thermal contact is made between the temperature sensor and the cell by the same element (clip) used to align and fasten the track to the harness.

The harness assembly may comprise an electrically conductive branch track electrically connected at a first end of the branch track to the track and branching off from the track, the branch track configured to be angled non-parallel to the track and located at least partially at a second side of the battery module; and a branch temperature sensor located at a second end of the branch track of the track opposite the first end of the branch track, the branch temperature sensor configured to sense temperature at the second side of the battery module. Such a branch track may advantageously allow for a temperature sensor to be attached to a different region of the electrical cells than a sensor on the main electrical track to monitor temperature in a different way and give a more complete overview of module temperature by monitoring a different region of the cell(s).

The branch temperature sensor may comprise a thermistor. The thermistor of the branch temperature sensor may be potted in thermally conductive material.

The branch track may be configured to be twisted (i.e. folded) with respect to the track, to thereby angle it non-parallel to the track and locate it at least partially at the second side of the battery module. The branch temperature sensor may be configured to sense a gas venting event from a cell of the battery module. Twisting/folding the branch track may be done in a way which retains a good electrical pathway from the main track to a branch temperature sensor. It is desirable to hold the main electrical track away from a module side where a gas venting event (e.g. a faulty cell breaks down and emits gas) may take place as the gas venting may damage the main electrical track. However, it is also desirable to be able to monitor the regions where a gas vent event may take place to be able to respond quickly to the problem. By using a branch track and locating it at a possible gas vent location on the module, both a gas venting event can be quickly detected, because a sensor is located close to the gas vent location, and also the likelihood of the gas vent event damaging the track is reduced by locating the main track away from a gas vent event location.

In a further aspect there is provided a battery module assembly for an electric vehicle. The battery module assembly comprises: a battery module comprising a plurality of electrical cells, the battery module comprising first and second opposite end faces with a side located therebetween; and any harness assembly disclosed herein; wherein the track of the harness assembly is located along the side of the battery module; and the harness clip of the harness assembly fastens the track to the battery module and holds the temperature sensor in contact with an electrical cell of the plurality of cells of the battery module.

The battery module assembly may further comprise a connector at a connector end of the track of the harness assembly, the connector configured to connect to a battery module controller and provide electrical signals from the track to the battery module controller; and a battery module controller configured to receive electrical signals from the track and provide an indication of the received electrical signals to a battery module controller. The battery module controller may also be called a cell supervision circuit (CSC) in some examples.

In a further aspect there is provided a battery pack comprising a plurality of electrically connected battery modules as disclosed herein.

In a further aspect there is provided a vehicle comprising any harness assembly, any battery module assembly or battery pack disclosed herein.

In a further aspect there is provided a method of forming a harness assembly for a battery module, the battery module comprising first and second opposite end faces with a side located therebetween. The method comprises:
forming an electrically conductive track;
electrically connecting a temperature sensor to the track; and
locating a harness clip on the track, the harness clip configured to fasten the track to the battery module and hold the temperature sensor in contact with an electrical cell of the battery module. The battery module may be of an electrical vehicle.

The temperature sensor may comprise a thermistor, and the method may further comprise applying thermally conductive potting material around the thermistor; the potting material configured to be cured and form a thermal connection between the electrical cell in contact with the thermistor and the thermistor when the harness assembly is attached to the battery module by the harness clip.

According to an aspect of this disclosure, there is provided a harness for a battery module of an electric vehicle, the battery module comprising first and second opposite end faces, a first side located between the first and second opposite end faces, and a second side different to the first side and located between the first and second opposite end faces. The harness comprises: a primary track comprising a printed electrical conductor, the primary track configured to be located along the first side of the battery module; and a branch track comprising a printed electrical conductor, the branch track electrically connected to the electrical conductor of the primary track, the branch track configured to be folded to locate the branch track at least partially at the second side of the battery module.

The branch track may be configured to be folded such that, when folded, the branch track covers a portion of itself in a fold portion of the branch track.

The primary track and branch track may be formed as portions of a track sheet, the track sheet comprising a first surface and an opposite second surface. The first surface of the primary track portion of the track sheet may be configured to be located against the first side of the battery module, and when folded, the second surface of the branch track portion of the track sheet may be configured to be located against the second side of the battery module when the harness is installed on the battery module.

The primary track and branch track may be formed as substantially parallel track portions of the track sheet. When the branch track is folded, the branch track portion may be oriented perpendicular to the primary track portion.

The first and second sides of the battery module may be adjacent with an edge therebetween, and oriented at right angles to each other. The branch track may comprise a bend portion configured to locate the branch track on the second side of the battery module. The branch track may comprise a right angular bend configured to be located at the edge and locate the branch track on the second side of the battery module.

The branch track may comprise a temperature sensor electrically connected to the branch track. The branch track may be attached to the primary track at a first end, and the harness may comprise a temperature sensor at a second end of the branch track opposite the first end. The temperature sensor may be configured to sense temperature at the second side of the battery module.

The battery module may comprise a plurality of electrical cells each having parallel longitudinal axes aligned in a first direction parallel to the plane of the first side of the battery module. The temperature sensor may be configured to be located, in use, adjacent to an end of at least one of the plurality of electrical cells at the second side of the battery module.

The temperature sensor may be a thermistor.

The primary track may be electrically connected to a controller. The controller may be configured to: receive electrical signals from the temperature sensor via the branch track and the primary track; and determine, based on the received electrical signals, whether the battery module is operating within a predetermined operating temperature range. If the battery module is operating outside the predetermined operating temperature range, this may be determined by the controller, based on temperature sensed by the temperature controller, that the battery is or will shortly be operating in an overheating state, such as if there is a gas venting event from an electrical cell of the battery module sensed by the temperature sensor.

The harness may comprise an adhesive portion configured to, in use, be located between the branch track and the second side of the battery module, thereby attaching the branch track to the second side.

The harness may comprise a plurality of branch tracks spatially separated along the length of the primary track.

The harness may comprise at least one harness clip configured to fasten the primary track to the battery module.

According to an aspect of this disclosure, there is provided a battery module assembly for an electric vehicle, the battery module assembly comprising: a battery module comprising first and second opposite end faces, a first side located between the first and second opposite end faces, and a second side different to the first side and located between the first and second opposite end faces; and any harness described herein; wherein the primary track is located along the first side of the battery module; and the branch track is folded and located at least partially at the second side of the battery module.

Thee branch track may be attached to the primary track at a first end. The harness may comprise a temperature sensor at a second end of the branch track opposite the first end, the temperature sensor configured to sense temperature at the second side of the battery module.

The battery module assembly may comprise an adhesive portion located between the branch track and the second side of the battery module, thereby attaching the branch track to the second side.

The temperature sensor may be potted in thermally conductive material. It may be potted on the second side of the battery module. The temperature sensor may be in contact with, and bonded to, an electrical cell of the battery module. It may be bonded to and in contact with the second side of the battery module.

According to an aspect of this disclosure, there is provided a battery pack comprising a plurality of electrically connected battery module assemblies as described herein.

According to an aspect of this disclosure, there is provided a vehicle comprising any harness, battery module assembly, or battery pack disclosed herein.

According to an aspect of this disclosure, there is provided a method of forming a harness for a battery module, the battery module comprising first and second opposite end faces, a first side located between the first and second opposite end faces, and a second side different to the first side and located between the first and second opposite end faces; the method comprising: forming, as a planar track sheet, a primary track comprising a printed electrical conductor and a branch track comprising a printed electrical conductor electrically connected to the electrical conductor of the primary track; and preparing the branch track to be folded to allow the primary track to be located along the first side of the battery module and allow the branch track to be located at least partially at the second side of the battery module.

The method may comprise electrically connecting a temperature sensor to the branch track, the temperature sensor to be located against the second side of the battery module.

According to an aspect of this disclosure, there is provided a method of forming a battery module assembly, comprising: providing a battery module comprising a plurality of electrical cells, the battery module comprising first and second opposite end faces, a first side located between the first and second opposite end faces, and a second side different to the first side and located between the first and second opposite end faces; forming, as a planar track sheet, a primary track comprising a printed electrical conductor and a branch track comprising a printed electrical conductor electrically connected to the electrical conductor of the primary track; folding the branch track at a fold portion to cause the branch track to be oriented non-parallel with the primary track; locating the primary track along the first side of the battery module; locating the branch track at least partially at the second side of the battery module by bending the branch track from the first side of the battery module over to the second side of the battery module; attaching the primary track to the first side of the battery module; and attaching the branch track to the second side of the battery module.

The method may comprise electrically connecting a temperature sensor to the branch track for location at the second side of the battery module; applying thermally conductive potting material around the temperature sensor located at the second side of the battery module; and curing the potting material configured to form a thermal connection between an electrical cell in contact with the temperature sensor and the temperature sensor.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments will now be described by way of example only, with reference to the accompanying figures, in which:

FIG. 1a shows an example traction battery assembly according to examples of the present disclosure;

FIG. 1b shows an example battery module assembly according to examples of the present disclosure;

FIG. 2 shows an example harness according to examples of the present disclosure;

FIG. 3a-3b show an example harness clip according to examples of the present disclosure;

FIG. 4a-4b show example harness clips according to examples of the present disclosure;

FIG. 5 shows an example connector according to examples of the present disclosure;

FIG. 6 shows an example of a branch track according to examples of the present disclosure;

FIG. 7 shows an example method of forming a harness assembly for a battery module of an electric vehicle according to examples of the present disclosure;

FIG. 8 shows an example method of forming a harness according to examples of the present disclosure;

FIG. 9 shows an example method of forming a battery module assembly according to examples of the present disclosure; and

FIG. 10 shows an example vehicle according to examples of the present disclosure.

### DETAILED DESCRIPTION

Improving battery technology and battery manufacture, for example for use in electric vehicles, is important in view of recent interest in providing cleaner energy solutions. An electric vehicle may be, for example, a battery electric vehicle (BEV), a hybrid electric vehicle (HEV), or a plug-in hybrid electric vehicle (PHEV). A battery module may be considered to be any battery module of a vehicle, for example, a module of a battery (or a battery per se) which may be used to, for example, start the engine. A traction battery module may be considered to be a module of a traction battery (or a traction battery per se) which is used to drive the vehicle (i.e. power the powertrain to propel the vehicle).

A battery, or battery module (e.g. a traction battery module) for an electric vehicle may comprise an array of electrical cells which may be located in a housing/casing. The electrical cells may be battery cells, for example rechargeable battery cells; and/or capacitors, such as supercapacitors, which are configured to store electrical charge. Electrical measurements may be taken from the cells via connection of the cells to a busbar, and from there, to a connection outside the battery (or battery module) for measurement readout.

An area for improvement is taking sensor measurements from the battery cells. For example, it is important to be able to reliably monitor the voltage, temperature, or other parameters of the battery to check its operation, for example for safety and battery health monitoring.

Temperature monitoring may be performed using a temperature sensor in close proximity or in contact with a body to be monitored, such as an electrical cell. It is important to have a secure and robust fixing of the temperature sensor in place in the battery module, to have high confidence that any temperature readouts from that sensor are indeed obtained from the element being monitored (that is, if the sensor is intended to be fixed to the side of an electrical cell but the fixing is not secure enough, as the vehicle in which the battery is located is used, vibrations and shocks may dislodge the temperature sensor out of position and it may no longer accurately detect the temperature of the electrical cell).

Furthermore, it is also desirable not only for the temperature sensor to be held in position well, but for any electrical connection from the sensor to an output of the batter module to also be robustly located and affixed in the battery module to mitigate against damage to the electrical connections or breakages in the electrical pathway through use of the vehicle. It is also advantageous from a manufacturing viewpoint for the temperature sensor and the electrical connections attached to it to be easy to manufacture and assemble in the battery module manufacturing process.

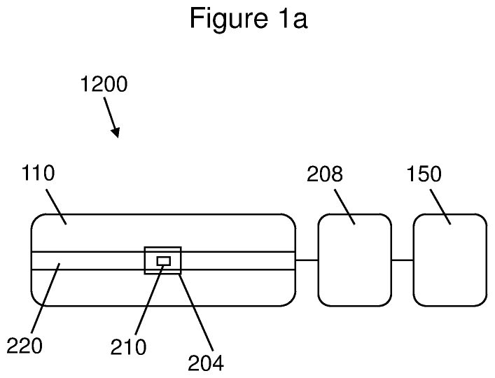

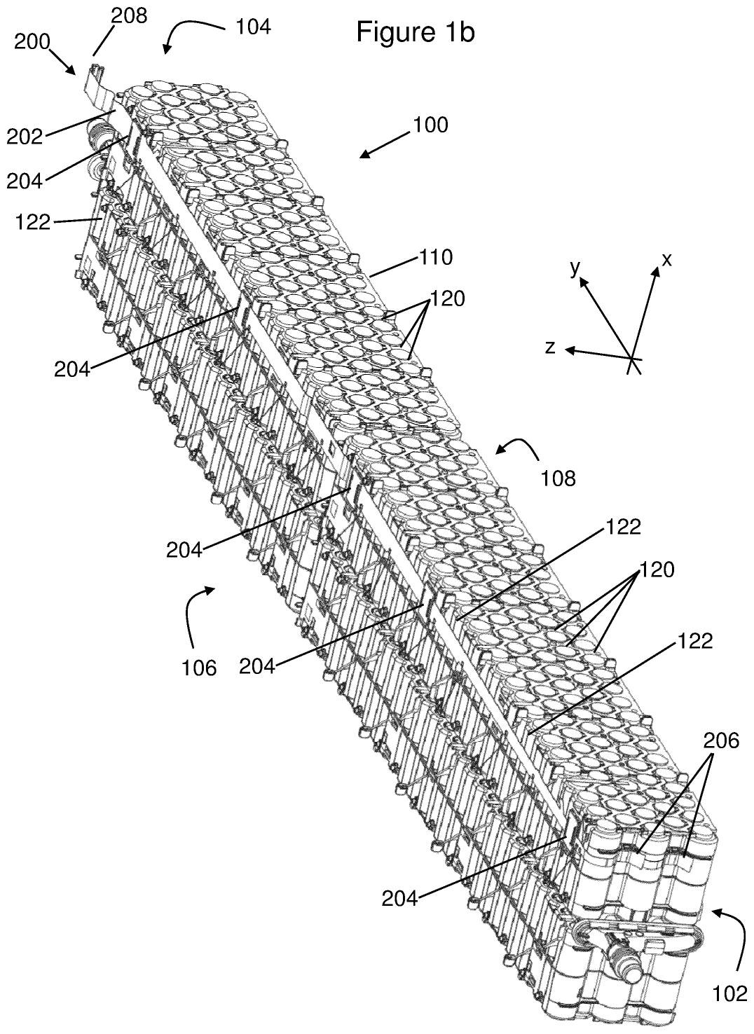

FIG. 1a shows a schematic example of battery pack 1200 comprising a battery module 110; a harness assembly comprising a harness 220, a temperature sensor 210 and a harness clip 204 securing the track of the harness 220 to the battery module 110; a connector 208 at an end of, and electrically connected to, the harness 220; and a battery module controller 150 (e.g. a cell supervision circuit (CSC)) electrically connected to the connector 208 (i.e. the harness 220 is electrically connected to the CSC 150 by the connector 208). A battery pack may comprise a battery module 110 or a plurality of electrically connected battery modules 110 each having respective harness assemblies 200, connectors 208 and CSCs 150.

FIG. 1b shows an example of a battery module assembly 100, for example, for use as part of a battery such as a traction battery in an electric vehicle. The battery module assembly 100 comprises a battery module 110 and a harness assembly 200.

The battery module 110 comprises first and second opposite end faces 102, 104 with a side 106 located therebetween. In this example the battery module 110 is approximately cuboid with a plurality of electrical cells 120 arranged in an aligned array. In this example the cells 120 are all aligned in the same direction and stacked together in a space-efficient arrangement to minimise wasted space between cells 120. The cells 120 are aligned so that ends of the aligned cells are located at two opposite sides of the module 110 and sides of the aligned cells are located at the other two opposite sides including the side 106 where a harness assembly 200 is located. The cells 120 may be held in alignment in a support frame, which may be called a cell carrier 122. A cell carrier 122 is a structure which supports the plurality of electrical cells of the battery module in an array. For example, a cell carrier 122 may be a frame of rigid insulating scaffolding in which a cell array may be securely fitted to hold the cells in place in a desired array pattern.

The harness assembly 200 is present as part of the battery module assembly 100. The track 202 of the harness assembly 200 is located along the side 106 of the battery module 110. The electrically conductive track 202 of the harness assembly 200 comprises a plurality of electrically conductive strips (e.g. copper wires or tracks) located on an electrically insulating support layer. The track 202 is configured to be located along the side 106 of the battery module 110, across a plurality of electrical cells 120 of the battery module 110, with the electrically insulating support layer between the plurality of electrically conductive strips and the battery module side 106.

Harness clips 204, 206 of the harness assembly fasten the track 202 to the battery module 110 and hold respective temperature sensors in contact with respective electrical cells of the plurality of cells of the battery module 110. The cells of the plurality of electrical cells 120 each have parallel longitudinal axes aligned in a first direction (in this example, the longitudinal axes are in the x-direction) parallel to the plane (as shown, in the x-y plane) of the side 106 along which the harness assembly 200 is located. The harness assembly 200 comprises at least one temperature sensor which is in contact with, and bonded to, an electrical cell 120 of the battery module 110.

The clips 204, 206 hold the harness assembly 200 securely in place on the battery module 110. The clips 204, 206 help ensure good contact of the temperature sensor(s) with the electrical cell(s) 120 they are adjacent to, and help to retain the electrically connecting track 202 in position along the side 106 of the battery module 110. Thus the clips 204, 206 aid in manufacturing a compact battery module 110 with securely retained sensor(s) and well located electrical connection(s) in the form of the track 202 held in place by the clips 204, 206. Further, the clips 204, 206 are readily manufactured (e.g. from moulded plastic) and are easy to install by clicking into place into a corresponding clip location on the battery module 110 (e.g. in a cell carrier 122).

The battery module assembly 100 also comprises a connector 208 at a connector end of the track 202 of the harness assembly 200. The connector 208 is configured to connect to a battery module controller 150 and provide electrical signals from the track 202 to the battery module controller 150. The battery module controller 150 may be called a cell supervision circuit (CSC) in some examples, and may receive electrical signals from a sensor in the battery module, such as a temperature sensor or electrical parameter sensor. In some examples the battery module controller 150 may perform some computation in dependence on the received signals, for example to determine whether the temperature indicated by the received temperature sensor signal is within a safe operating temperature.

A plurality of such battery modules 110 which are electrically connected may be termed a battery pack 1200. Such a battery pack may be installed in a vehicle (for example, it may be housed in a rigid housing and bolted to a structural portion of the vehicle, such as in the floor part of the vehicle.

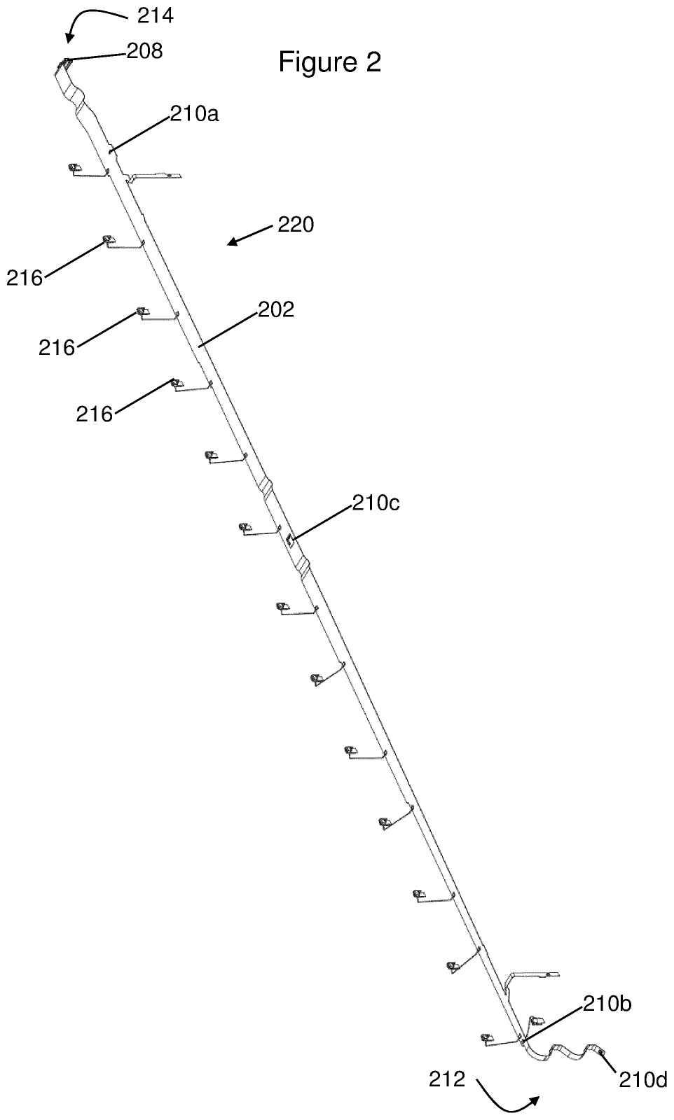

FIG. 2 shows an example harness 220 (without the harness clips present) prior to location on a battery module 110 as in FIG. 1. The harness 220 comprises an electrically conductive track 202 configured to be located along the side of the battery module; and at least one temperature sensor 210a-d electrically connected to the track 202. A connector 208 is also shown for connecting the harness 220 to a battery module controller. In FIG. 2, there is a temperature sensor 210a,b located at each end 212, 214 of the harness 220 which are to be located on the side of the battery module. Thus the harness 220 includes a temperature sensor 210a located towards the second end 214 of the track and the connector 208. Having temperature sensors 210a,b at either end of the harness 220, and thus at either end of the side 106 of the battery module, may provide an indication of any variation in temperature across the length of the battery module.

Also shown is a temperature sensor 210c located in the middle of the harness which is to be located in the middle of the side of the battery module (i.e. midway between the battery module ends). Having a plurality of temperature sensors 210a-c spaced along the side of the battery module may provide an accurate temperature profile across the battery module and, if one sensor fails, the remaining operational sensors may still be used to monitor battery temperature.

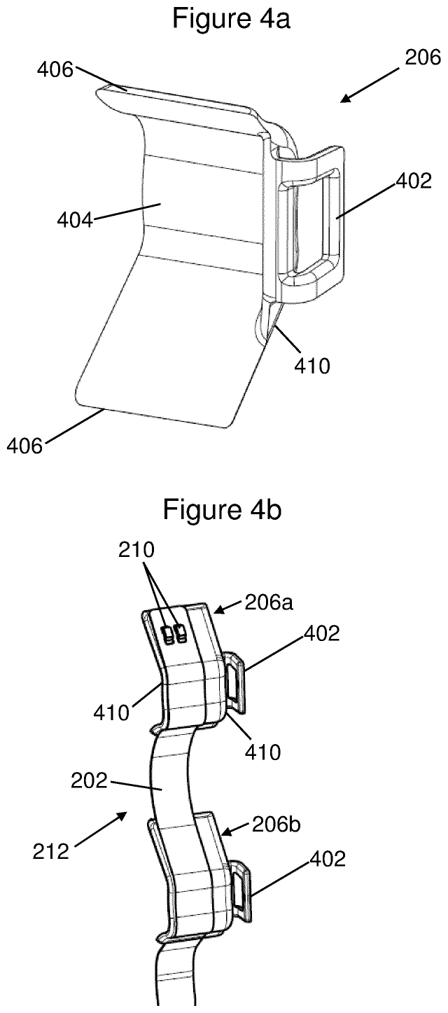

Also shown is a temperature sensor 210d located at the end of the harness 220 which is to be located at the end face of the battery module rather than on the side. That is, the harness 220 in FIG. 2 comprises a temperature sensor 210d which is located at a first end 212 of the track. A harness clip may be configured to fasten the first end 212 of the track 202 to an end face of the battery module and hold the temperature sensor 210d in contact with an electrical cell at the end of the battery module. Such a clip is discussed in relation to FIGS. 4a-4b. Temperature monitoring at the end of the battery module may be useful as the ends of the battery module tend to reach the highest temperatures across the whole battery module so this is a useful place to check if the battery module is operating within a desired temperature range.

One or more of the temperature sensors 210a-d may comprise a thermistor. Such a thermistor may be potted in thermally conductive material. Potting the thermistor in thermally conductive potting material may help to ensure good thermal contact with the electrical cell being monitored, because it helps to minimise any air gaps between the thermistor and the battery cell of which the temperature is being monitored. Thus the accuracy of temperature sensed by the thermistor may be improved. In addition, the potted thermistor may be assembled in the battery module by potting the thermistor, and partially curing the potting material. Then the potted thermistor is located at the required location in the battery module (e.g. against the an electrical cell) and the curing process of the potting material may then be completed. In this way the thermistor may be adhered to the electrical cell by the potting material, improving the structural stability of the battery module and improving the connection of the temperature sensor, for example over time as the battery module is used in a vehicle. In combination with a harness clip holding the potted thermistor against the electrical cell, the temperature monitoring ability of the temperature sensor is improved by ensuring excellent thermal contact over prolonged time period and over the use of the battery in a vehicle.

Also shown in this example are a series of voltage connectors 216 which are configured to connect to connector locations on a battery module busbar, itself forming a connection to terminals of the plurality of electrical cells of the battery module. In this way, electrical measurements may be taken from the cells, such as voltage readings, and the measurements may be transmitted as electrical signals from the voltage connectors 216 along the conductive tracks of the harness 220 to the connector 208 for output. Thus the harness may act to transmit electrical signals from different types of sensor to a controller 150.

One or more harness clips 204, 206 as shown in FIG. 1 may be added to the harness 220 to form a harness assembly 200, and may be used to attach the harness 220 onto the battery module 110. A harness clip 204, 206 may be located over a temperature sensor 210a-d in some examples such that, once the harness clips 204, 20 are in use attaching the harness 220 to the battery module 110, the temperature sensor 210a-d is located between the clip and the battery module. In this way the clips 204, 206 provide a simple and secure way of fastening the harness 220 to the battery module 110 in a desired location, as well as helping provide good thermal contact between the temperature sensor 210a-d and the cell on which it is located to provide reliable temperature readings.

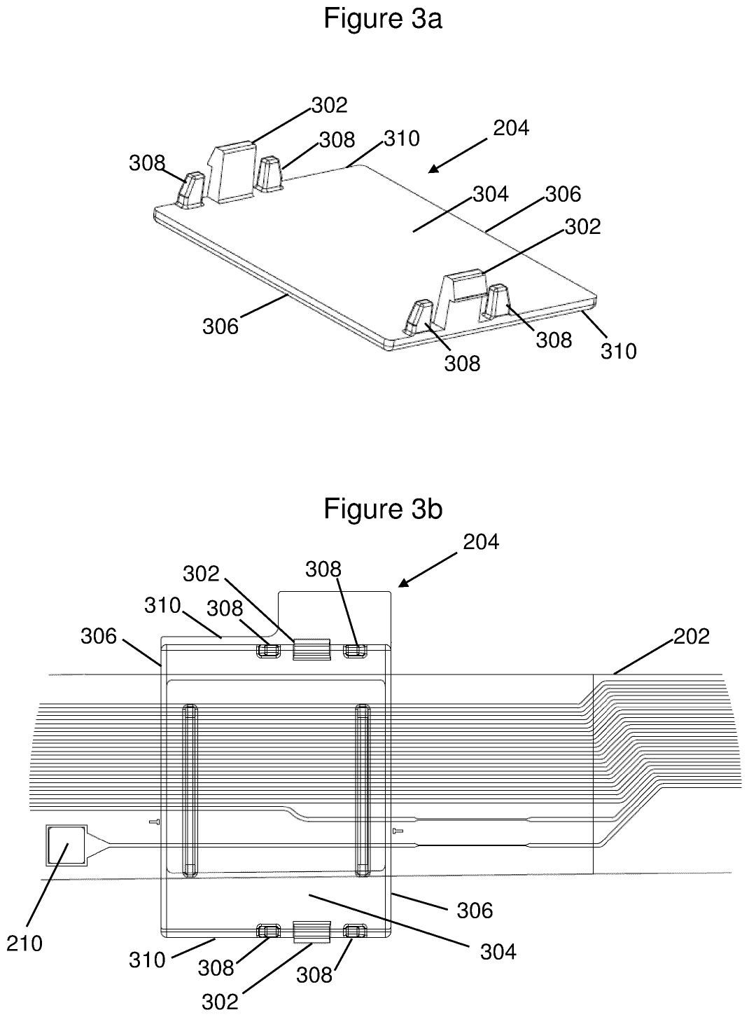

FIG. 3a-3b show an example harness clip 204. Such a form of harness clip 204 is configured to fasten the track 202 to the side of the battery module 110 and hold a temperature sensor 210 located on the harness in contact with an electrical cell at the side of the battery module.

FIG. 3a shows that the harness clip 204 comprises a central portion 304 and a pair of clip tabs 302 at opposite sides 310 of the central portion 304. The harness clip 204, as shown in FIG. 3b, is configured to hold the track 202 between the pair of clip tabs 302 and sandwich the track 202 between the central portion 304 and the battery module to which the harness clip can attach (by the tabs 302 slotting into corresponding holes of the battery module such as in a cell carrier of the module). In this example each clip tab 302 also has a pair of guide tabs 308 to either side of the clip tab 302 along the clip edge 310 of the harness clip 204. The clip tabs 302 and guide tabs 308 to either side of the clip tabs 302 along the clip edge 310 of the harness clip act to hold the harness in position by restricting the movement of the track 202 so that it cannot slip out of the clip edges 310 of the harness clip 204 when the harness is being attached to the battery module by the clip 204.

As shown in FIG. 3b, the temperature sensor in this example is not located between the harness clip 204 and the battery module but would be just outside one free edge 306 (i.e. an edge without a tab 302) of the clip 204. This may provide an advantage of allowing the temperature sensor to respond rapidly to the changing temperature of the cell to which it is located against without being significantly influenced by the thermal mass of the clip. The clip may be made from a thermally insulating material (in any example disclosed herein), such as a plastic, which may aid the temperature sensor detecting the temperature of the cell without undue influence from the nearby clip. In other examples the temperature sensor 210 may be located between the harness clip 204 and the battery module when the clip 204 is clipped into place on the battery module to sandwich the temperature sensor 210 between the central portion 304 and the battery module with the pair of clip tabs 302 located at respective opposite edges of the track 202.

The harness clip 204 may be configured to clip onto a cell carrier 122 of the battery module to affix it in position as part of the battery module assembly 100. It may be straightforward to manufacture both the harness clip 204 and cell carrier 122 such that protruding tabs 302 of the clip 204 can be slotted into corresponding holes in the cell carrier 122, thereby designating the location at which the harness clip 204 can be attached.

FIG. 4a-4b show example harness clips 206, 206a,b which are configured to affix to the end 102 of a battery module 110. In this example, the harness clip 206, 206a,b has a profile shaped to follow a curved surface of the end 102 of the battery module 110, and fasten the first end 212 of the track 202 to an end face 102 of the battery module 110 causing the first end 212 of the track 202 to conform to the curved surface. The curved surface comprises a central portion 404 between two opposite free edges 406. The curved surface may be described as having a convex face which in this example is to be located towards the battery module and an opposite concave face which is to face away form the battery module when the clip is in place. By being shaped to follow the curved profile of the end of the battery module 110 and cause the harness to follow the profile as well, a compact battery module assembly 100 is obtained and any loose wiring/cabling is minimised by conforming the harness track 202 to the side of the module 110.

Also in this example, the harness assembly 200 comprises a plurality of temperature sensors 210 (two are shown in this example) located at the first end 212 of the track 202. The harness clip 206a located with the temperature sensors 210 is configured to hold the plurality of temperature sensors 210 in contact with the electrical cell at the end of the battery module. In this example, the temperature sensors 210 would be located (sandwiched) between the clip 206a and the battery module 110. As with the clips in FIGS. 3a-3b, the harness clips 206, 206a,b are configured to clip onto a cell carrier 122 of the battery module. The harness clip 206 in this example is configured to sandwich the track 202 between the convex curved face of the central portion 404 and the battery module to which the harness clip 206 can attach. A clip portion 402 is present at a clip edge 410 of the clip 206 which may attach to a corresponding clip port/hole in the cell carrier 122, for example. There may be raised ridges along the clip edges 410 which, similarly to the clip tabs and guide tabs in FIG. 3a-3b, act to hold the harness 220 in place under the clip when the clip is being attached to the battery module 110.

It may be advantageous to monitor the electrical cell temperature at the end 102 of the battery module 110, because the cells at the highest temperature throughout the battery module 110 may be at this location. That is, cells at the end of the battery module 110 tend to get the hottest, and thus if an intervention should be made in the event of the battery module 110 becoming above a safe temperature threshold, it is advantageous to determine the temperature at the hottest place in the battery module 110, i.e. the end cells. Otherwise, if the temperature is measured at a location which is not the hottest location in the module, then the condition for causing an intervention to cool the module 110 down is triggered after the end cells have likely been at a temperature above the safety threshold for some time.

In this example, there are a plurality of temperature sensors 210 which may provide for additional safely through redundancy (i.e. two sensors are used to measure the temperature at approximately the same location on the battery module). If one of the sensors 210 fails, the remaining sensor 210 may still function as a backup sensor. In some examples an average reading of the two sensors 210 may be obtained for increased accuracy of temperature reading. In some examples, the reading of one of the two sensors 210 may be used as a check of the reading of the other sensor 210, so that if the temperature sensed by one of the sensors 210 is determined to vary strongly, it may be confirmed if the change is a real temperature change of the battery module, and thus may require safety intervention such as battery cooling or casing operation, or whether the temperature variation is a rogue reading or series of readings from a faulty sensor 210.

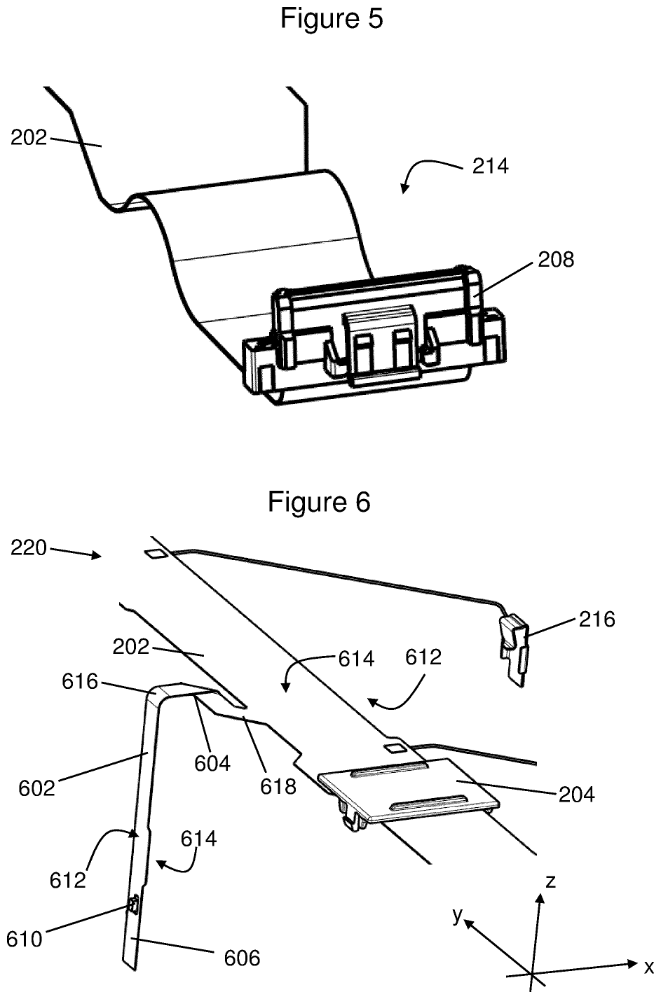

FIG. 5 shows an example connector 208 which may be located at a second end 214 of the track 202 (i.e. the opposite end of the track 202 to where the temperature sensors at the end of the battery module are located as shown in FIG. 1). The connector 208 is configured to connect to a battery module controller 150 (e.g. a cell supervision circuit, CSC), and provide electrical signals from the track 202 to the battery module controller 150. The connector 208 and the harness track 202 therefore provide a simple means of electrically connecting sensors located at various positions on the battery module 110 (e.g. temperature sensors, voltage monitoring connections) to a common output location at the connector 208 for transmission to a processor (e.g. a CSC 150) to manage the received sensor data.

FIG. 6 shows a portion of an example of a harness 220, showing an electrically conductive branch track 602 branching off from the main/primary harness track 202. As shown in place on a battery module 110 in FIG. 1b, the harness 220 is for a battery module 110 comprising first 102 and second 104 opposite end faces, a first side 106 located between the first and second opposite end faces, and a second side 108 different to the first side and located between the first and second opposite end faces 102, 104.

The harness 220 comprises a primary (main) track 202 comprising a printed electrical conductor. The primary track 202 is configured to be located along the first side 106 of the battery module 110. The harness 220 comprises a branch track 602 comprising a printed electrical conductor. The branch track 602 is electrically connected to the electrical conductor of the primary track 202. The branch track 602 is configured to be folded to locate the branch track at least partially at the second side 108 of the battery module. The printed electrical conductor(s) may be termed a flexible printed circuit board (fPCB), and so the harness may be called a fPCB module harness. A fPCB (also called flex circuit board) is a printed electrical circuit board having at least a portion which is flexible. For example, conductive strips may be printed onto a flexible substrate such an insulating material e.g. polyimide.

The branch track 602 is electrically connected to the track 202 at a first end 618 of the branch track. The branch track 602 is configured to be angled non-parallel to the main track 202 and located at least partially at a second side 108 of the battery module 110 (as shown the second side 108 would be in the y-z plane).

The primary track 202 and branch track 602 may be formed as portions of a track sheet (i.e. a fPCB printed in a sheet). The track sheet comprises a first surface 612 and an opposite second surface 614. The first surface 612 of the primary track portion 202 of the track sheet (i.e. the underside of the primary track 20) may be configured to be located against the first side 106 of the battery module 110, and when folded, the second surface 614 of the branch track 602 portion of the track sheet (i.e. the underside of the branch track 606, when folded) may be configured to be located against the second side 108 of the battery module 110 when the harness 220 is installed on the battery module 110. That is, the branch track 602 here is configured to be folded such that, when folded, the branch track 602 covers a portion of itself in a fold portion 604 of the branch track. In other words, it may be said that the branch track 602 is configured to be twisted (as shown, the twist is at the first end 618 of the branch track 602) with respect to the track 202. The twist aligns the long direction of the branch track 602 to be non-parallel to the long direction of the primary track 202.

The primary track 202 and branch track 602 may be formed as substantially parallel track portions of the track sheet (this can be understood from FIG. 6 in the portion of the branch track 602 between the fold portion 604 and the point of connection 618 to the primary track 202, which is oriented in the ±y direction in the same direction as the primary track 202). When the branch track 602 is folded as shown in FIG. 6 at the fold portion 604, the branch track portion 602 may be oriented perpendicular to the primary track portion 202. In FIG. 6, considering the portion of the branch track 602 between the fold portion 604 and the bend portion 616 the branch track 602, this perpendicular orientation due to the fold is in the ±x direction compared to the primary track 202 oriented in the ±y direction.

The branch track 602 is configured to be bent (as shown, the bend portion 616 with the bend is towards the first end 618 of the branch track 602) with respect to the track 202, to thereby angle it out of the plane to the track 202, and locate it at least partially at the second side of the battery module. A bend may be considered to be a flex of the track so that the track changes the geometric plane in which is lies (in this case, to be shaped to lie over the edge of the battery module over two adjacent faces) without folding/twisting the track. That is, the bend portion 616 causes the flat branch track to curve around the corner of the battery module. The plane of the primary track as shown in the x-y plane and the plane of the branch track 602, as shown in the folded and bent configuration, is in the y-x plane. The first 106 and second 108 sides of the battery module 110 may be adjacent with an edge therebetween, and oriented at right angles to each other, as shown in FIG. 1b. The branch track 602 may comprise a right angular bend portion 616 configured to be located at the edge and locate the branch track 602 on the second side 108 of the battery module 110. More generally, the branch track may comprise a bend portion which allows the branch track to be located at least partially in a different plane, such as on the second side of the battery module It may be counterintuitive to fold/twist or bend an electrical track or fPBC track in this way, but in this application it provides a neat way of providing electrical connection via flat printed electrical connections to temperature sensors 210, 610 at various locations on the surface of a battery module 110 and on different planar surfaces of the module 110.

The branch track 602 may comprise a temperature sensor 610 electrically connected to the branch track 602. The branch track 602 may be attached to the primary track 202 at a first end 618, and the harness 220 may comprise a temperature sensor 610 at a second end 606 of the branch track 602 opposite the first end 618. The temperature sensor 610 may be configured to sense temperature at the second side 108 of the battery module 110. The temperature sensor 610 may be a thermistor in some examples. The battery module 110 may comprise a plurality of electrical cells 120 each having parallel longitudinal axes aligned in a first direction (as shown, the x direction) parallel to the plane (the x-y plane) of the first side 106 of the battery module 110. The temperature sensor 610 may be configured to be located, in use, adjacent to an end of at least one of the plurality of electrical cells 120 at the second side 108 of the battery module 110.

The second side is a side which may be affected by a gas venting event from a cell of the battery module 110. At the second side of the battery module (for example, the upper facing second side 108 in the y-z plane as shown in FIG. 1), the ends of the electrical cells are located. If there is a cell fault such that a cell fails and causes gas to escape from the cell interior, this gas vent will likely occur from the end of the faulty cell at the second side of the module where the branch temperature sensor is located 610. The venting gas will be at an elevated temperature compared to the surroundings, and so a gas vent event may be detected by the branch temperature sensor. Locating the branch temperature sensor 610 close to the likely location of a gas vent event allows for quick and accurate detection of the event so that some safety or remedial action can be taken quickly. If the fault is not detected until the increase in temperature caused by the gas vent is detected elsewhere by a temperature sensor which is not necessarily very close to the cell ends, there is a delay is reacting to the fault, in which time further damage may be caused by the faulty cell (for example, neighbouring cell may be damaged). Locating a temperature sensor 610 close to a likely location of a gas vent event in this way may also help to meet legislative safety requirements for electrical cell use. By using a branch track 602, the main track 202 need not be located along the second side where gas vent events are most likely to occur, and which may damage the main track 202 of the harness 220 if the harness 220 is located close to the likely location of vent events.

The primary track 202 may be electrically connected to a controller as discussed in relation to FIG. 5. The controller may be configured to receive electrical signals from the temperature sensor 610 via the branch track 602 and the primary track 202; and determine, based on the received electrical signals, whether the battery module 110 is operating within a predetermined operating temperature range (e.g. a temperature range set to provide efficient battery charge usage, or a temperature range determined to be a safe temperature range). If the battery module 110 is operating outside, or is likely to start operating outside the predetermined operating temperature range, this may be determined by the controller, based on temperature sensed by the temperature controller 610. For example, if there is a gas venting event from an electrical cell 120 of the battery module, this will cause the temperature to rise which would be sensed by the temperature sensor 610. The controller may then provide a signal, for example to an output UI or further controller, to indicate the temperature behaviour of the battery module.

The harness 220 may comprise an adhesive portion (now shown) configured to, in use, be located between the branch track 602 and the second side 108 of the battery module 110, thereby attaching the branch track 602 to the second side 108.

The harness 220 may comprise a plurality of branch tracks 602 spatially separated along the length of the primary track 202. Thus temperature sensors may be located at spatially separated points along the length of the second side 108. The harness 220 may comprise (or be used with) at least one harness clip 204, 206 as discussed in detail above to fasten the primary track to the battery module.

The battery module assembly 100 of FIG. 1b may comprise a harness 220 as discussed above; wherein the primary track 202 is located along the first side 106 of the battery module 110 and the branch tracks 602 (there are plural branch tracks in this example) are folded and located at least partially at the second side 108 of the battery module 110. The temperature sensor 610 may be potted in thermally conductive material. It may be potted on the second side 108 of the battery module. The temperature sensor 610 may be in contact with, and bonded to, the second side of the battery module, and may be bonded to and in contact with an electrical cell of the battery module.

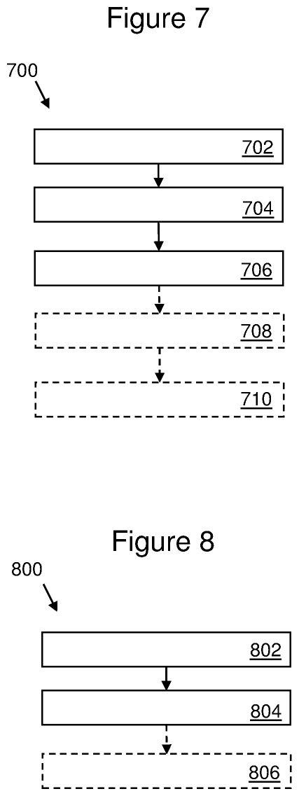

FIG. 7 shows an example method 700 of forming a harness assembly for a battery module of an electric vehicle, wherein the harness assembly and battery module together form a battery module assembly. The battery module as discussed above comprises first and second opposite end faces with a side located therebetween. The method 700 comprises: forming an electrically conductive track 702; electrically connecting a temperature sensor to the track 704; and locating a harness clip on the track 706. Locating the harness clip is performed so that the clip can fasten the track to the battery module and hold the temperature sensor in contact with an electrical cell of the battery module.

The temperature sensor may comprise a thermistor, for example a potted thermistor. In some examples, the method 700 may further comprise applying thermally conductive potting material around the thermistor 708. The potting material is configured to be cured and form a thermal connection between the electrical cell in contact with the thermistor and the thermistor when the harness assembly is attached to the battery module by the harness clip. The method may thus further comprise completing curing the potting material once the potted sensor is in position in contact with the battery module 710. Thus may help to retain the sensor in the same position on the cell by bonding the sensor to the cell.

FIG. 8 illustrates a method 800 of forming a harness for a battery module such as shown in FIG. 1b, wherein the battery module comprises first and second opposite end faces, a first side located between the first and second opposite end faces, and a second side different to the first side and located between the first and second opposite end faces. The method 800 comprising: forming 802, as a planar track sheet, a primary track comprising a printed electrical conductor and a branch track comprising a printed electrical conductor electrically connected to the electrical conductor of the primary track; and preparing 804 the branch track to be folded to allow the primary track to be located along the first side of the battery module and allow the branch track to be located at least partially at the second side of the battery module. The method 800 may comprise electrically connecting 806 a temperature sensor to the branch track, wherein the temperature sensor is to be located against the second side of the battery module.

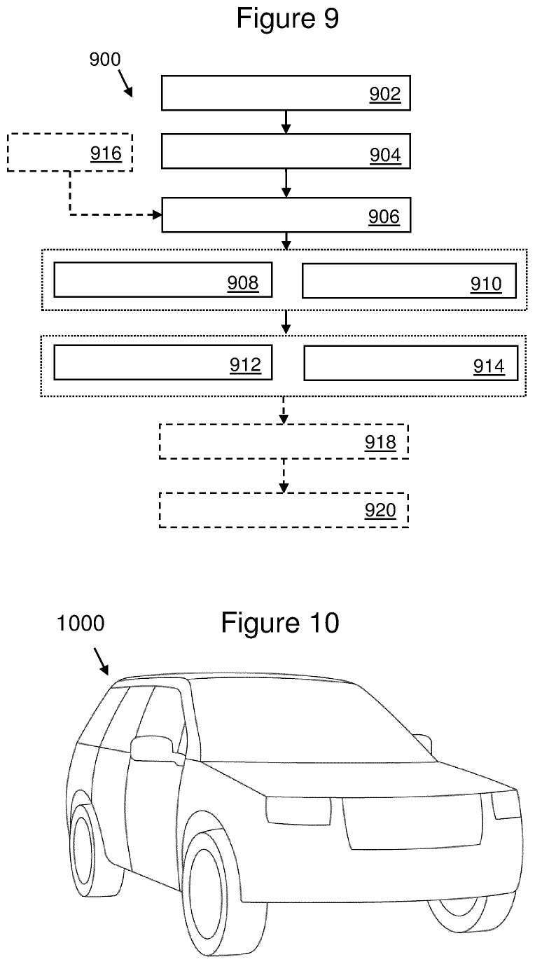

FIG. 9 illustrates a method 900 method of forming a battery module assembly. The method comprises providing a battery module 902 comprising a plurality of electrical cells, the battery module comprising first and second opposite end faces, a first side located between the first and second opposite end faces, and a second side different to the first side and located between the first and second opposite end faces. The method 900 comprises forming 904, as a planar track sheet, a primary track comprising a printed electrical conductor and a branch track comprising a printed electrical conductor electrically connected to the electrical conductor of the primary track; folding 906 the branch track at a fold portion to cause the branch track to be oriented non-parallel with the primary track; locating 908 the primary track along the first side of the battery module; locating 910 the branch track at least partially at the second side of the battery module by bending the branch track from the first side of the battery module over to the second side of the battery module; attaching 912 the primary track to the first side of the battery module; and attaching 914 the branch track to the second side of the battery module. The method 900 may comprise electrically connecting 916 a temperature sensor to the branch track for location at the second side of the battery module; applying 918 thermally conductive potting material around the temperature sensor located at the second side of the battery module; and curing 920 the potting material configured to form a thermal connection between an electrical cell in contact with the temperature sensor and the temperature sensor. It will be appreciated that while FIG. 9 shows an example order/flow of method steps, the method steps may be performed in a different order in other examples.

It will be appreciated that certain examples disclosed herein can be realised, at least partially, in the form of hardware, software or a combination of hardware and software; for example software to control a control system to perform at least a part of a method as discussed above e.g. in an automated or semi-automated process. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. Such software may comprise computer readable code stored on a non-transitory computer-readable storage medium. It will be appreciated that the storage devices and storage media are embodiments of machine-readable storage that are suitable for storing a program or programs that, when executed, implement embodiments disclosed herein. Accordingly, embodiments provide a program comprising code for implementing a system or method as claimed in any preceding claim and a machine readable storage storing such a program. Still further, embodiments disclosed herein may be conveyed electronically via any medium such as a communication signal carried over a wired or wireless connection and embodiments suitably encompass the same.

FIG. 10 shows an example vehicle 1000. The vehicle 1000 comprising any harness 220 disclosed herein, harness assembly 200 disclosed herein, any battery module 110 disclosed herein, any battery module assembly 100 disclosed herein, or any battery pack disclosed herein.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A harness for a battery module of an electric vehicle, the battery module comprising first and second opposite end faces, a first side located between the first and second opposite end faces, and a second side different to the first side and located between the first and second opposite end faces, the harness comprising:
a primary track comprising a printed electrical conductor, the primary track configured to be located along the first side of the battery module; and
a branch track comprising a printed electrical conductor, the branch track electrically connected to the printed electrical conductor of the primary track, the branch track configured to be folded to locate the branch track at least partially at the second side of the battery module.

2. The harness of claim 1, wherein the branch track is configured to be folded such that, when folded, the branch track covers a portion of itself in a fold portion of the branch track.

3. The harness of claim 1, wherein
the primary track and branch track are formed as portions of a track sheet, the track sheet comprising a first surface and an opposite second surface; and
the first surface of the primary track portion of the track sheet is configured to be located against the first side of the battery module, and when folded, the second surface of the branch track portion of the track sheet is configured to be located against the second side of the battery module when the harness is installed on the battery module, and optionally wherein the primary track and branch track are formed as substantially parallel track portions of the track sheet, and wherein, when the branch track is folded, the branch track portion is oriented perpendicular to the primary track portion.

4. The harness of claim 1, wherein the first and second sides of the battery module are adjacent with an edge therebetween, and oriented at right angles to each other, and wherein the branch track comprises a right angular bend configured to be located at the edge and locate the branch track on the second side of the battery module.

5. The harness of claim 1, wherein the branch track comprises a temperature sensor electrically connected to the branch track, and/or wherein the branch track is attached to the primary track at a first end, and wherein the harness comprises a temperature sensor at a second end of the branch track opposite the first end, the temperature sensor configured to sense temperature at the second side of the battery module.

6. The harness of claim 5, wherein the battery module comprises a plurality of electrical cells each having parallel longitudinal axes aligned in a first direction parallel to a plane of the first side of the battery module; and
wherein the temperature sensor is configured to be located, in use, adjacent to an end of at least one of the plurality of electrical cells at the second side of the battery module.

7. The harness of claim 5, wherein the primary track is electrically connected to a controller, and wherein the controller is configured to:
receive electrical signals from the temperature sensor via the branch track and the primary track; and
determine, based on the received electrical signals, whether the battery module is operating within a predetermined operating temperature range.

8. The harness of claim 1, wherein the harness comprises an adhesive portion configured to, in use, be located between the branch track and the second side of the battery module, thereby attaching the branch track to the second side.

9. The harness of claim 1, comprising a plurality of branch tracks spatially separated along a length of the primary track, and/or comprising at least one harness clip configured to fasten the primary track to the battery module.

10. A battery module assembly for an electric vehicle, the battery module assembly comprising:
a battery module comprising first and second opposite end faces, a first side located between the first and second opposite end faces, and a second side different to the first side and located between the first and second opposite end faces; and
the harness of claim 1; wherein
the primary track is located along the first side of the battery module; and
the branch track is folded and located at least partially at the second side of the battery module.

11. The battery module assembly of claim 10, wherein the branch track is attached to the primary track at a first end, and wherein the harness comprises a temperature sensor at a second end of the branch track opposite the first end, the temperature sensor configured to sense temperature at the second side of the battery module.

12. The battery module assembly of claim 10, comprising an adhesive portion located between the branch track and the second side of the battery module, thereby attaching the branch track to the second side.

13. The battery module assembly of claim 11, wherein the temperature sensor is potted in thermally conductive material.

14. The battery module assembly of claim 11, wherein the temperature sensor is in contact with, and bonded to, an electrical cell of the battery module.

15. A battery pack comprising a plurality of electrically connected battery module assemblies of claim 10.

16. A vehicle comprising the harness of claim 1.

17. A method of forming a harness for a battery module, the battery module comprising first and second opposite end faces, a first side located between the first and second opposite end faces, and a second side different to the first side and located between the first and second opposite end faces; the method comprising:
forming, as a planar track sheet, a primary track comprising a printed electrical conductor and a branch track comprising a printed electrical conductor electrically connected to the printed electrical conductor of the primary track; and
preparing the branch track to be folded to allow the primary track to be located along the first side of the battery module and allow the branch track to be located at least partially at the second side of the battery module.

18. The method of claim 17, comprising:
electrically connecting a temperature sensor to the branch track, the temperature sensor to be located against the second side of the battery module.

19. A method of forming a battery module assembly, comprising:
providing a battery module comprising a plurality of electrical cells, the battery module comprising first and second opposite end faces, a first side located between the first and second opposite end faces, and a second side different to the first side and located between the first and second opposite end faces;
forming, as a planar track sheet, a primary track comprising a printed electrical conductor and a branch track comprising a printed electrical conductor electrically connected to the printed electrical conductor of the primary track;
folding the branch track at a fold portion to cause the branch track to be oriented non-parallel with the primary track;
locating the primary track along the first side of the battery module;
locating the branch track at least partially at the second side of the battery module by bending the branch track from the first side of the battery module over to the second side of the battery module;
attaching the primary track to the first side of the battery module; and
attaching the branch track to the second side of the battery module.

20. The method of claim 19, further comprising:
electrically connecting a temperature sensor to the branch track for location at the second side of the battery module;
applying thermally conductive potting material around the temperature sensor located at the second side of the battery module; and
curing the thermally conductive potting material configured to form a thermal connection between an electrical cell in contact with the temperature sensor and the temperature sensor.
